(19) United States
(12) Patent Application Publication
(10) Pub. No.: US 2003/0183726 A1
(43) Pub. Date: Oct. 2, 2003

(54) Space cargo delivery apparatus

(76) Inventors: John M. Lounge, Bayou Vista, TX (US); Frank Eichstadt, Kemah, TX (US); Glen Brown, Santa Cruz, CA (US)

Correspondence Address: ROSSI & ASSOCIATES, P.O. Box 826, Ashburn, VA, 20146-0826, US

(21) Appl. No.: 10/108,200

(22) Filed: Mar. 27, 2002

(51) Int. Cl. B64G 1/22; B64G 1/00

(52) U.S. Cl. 244/158 R

(57) ABSTRACT

A space cargo delivery apparatus and method has a flexible beam member, an end base, and stabilizing thrusters spaced along the length of the beam member for stabilizing and guiding the beam member. The end base is positioned at the distal end of the beam member. The beam member is inflatable so that it can support a compression load. The apparatus further has a retractor, which is connected to a proximal end of the beam member for storing the beam member in a deflated state and for controlling the amount of the beam member extending from the retractor in an inflated state. Alternatively, instead of the stabilizing thrusters, the delivery apparatus can use flexible beam members and a corresponding number of retractors to store the beam members and to control the lengths thereof extending from the retractors so that the end base can move in a relatively straight line.

### BACKGROUND

With the advent of the International Space Station (ISS), more frequent space expeditions have been scheduled to haul cargo to the ISS Current cargo transfer vehicles are required to dock to the ISS to load and unload pressurized cargo. External payload packages can be manipulated from the transfer vehicles to the ISS using a mechanical arm. A video imaging system and markings on the objects are used to assist the maneuver of the space crane. Canada recently launched a Canadarm2, also named Space Station Remote Manipulator System (SSRMS), which is a 58-foot-long, self-relocatable mechanical arm capable of moving around like an inchworm. One end of the Canadarm2 can be latched to any of the ports (Power and Data Grapple Fixtures (PDGFs)) spread throughout the ISS, while the other end remains latched to one of the PDGFs. The other arm end can then be detached so that the arm can be manipulated from a new position. Additional mechanical arms, such as Canada Hand and European Robotic Arm (ERA), have been contemplated for installment in the future.

As the ISS grows, its structure will inherently become larger and more intricate. The ISS currently carries relatively large solar panels and antennas that span across a large area. The future will invariably bring additional attachments and arrays. To get close to the ISS's main structure, where docking ports are located, cargo transfer vehicles will be required to exercise a greater degree of care and more precise maneuvering to avoid collision with the structures of the ISS. With more frequent missions needed to replenish supplies to the ISS, there is an increasing risk of a mishap. When cargo transfer vehicles are positioned near the ISS, docking movements must be precisely coordinated to avoid such a mishap that could lead to a collision

In view of the above, it would be desirable to have a system of delivering cargo to the ISS (or between space vehicles) from a relatively safe distance to promote a collision free environment.

### SUMMARY

The present invention relates to an apparatus and a method of delivering objects between orbiting space vehicles or stations.

One aspect of the present invention is a delivery apparatus that has at least one flexible beam member, an end base, and a plurality of stabilizing thrusters. The beam member has a predetermined length, sufficient to span between the points of delivery. The end base is formed or connected to the distal end of the beam member. The stabilizing thrusters are spaced along the length of the beam member for stabilizing and guiding the beam member so that the end base can move in a relatively straight line.

Another aspect of the present invention is a delivery apparatus that has a plurality of flexible beam members. In this embodiment, the end base is also formed at or connected to the distal end of each of the beam members. Instead of the stabilizing thrusters, this embodiment uses a plurality of retractors corresponding in number with the beam members to store the beam members and to control the length of the beam members extending from the retractors so that the end base can move in a relatively straight line.

Another aspect of the present invention is a method of transporting an object in space between a first position and a second position. This method uses at least one flexible beam member having a length to span between the first and second positions and an end base at a distal end of the beam member. The end base can be advanced or retracted from the first position to the second position or from the second position to the first position. While advancing or retracting the end base, the beam member can be guided and controlled so that the end base can move in a relatively straight line.

Yet another aspect of the present invention is a method of transporting an object in space between a first position and a second position using a plurality of flexible beam members having a length to span between the first and second positions. Similarly, this method also uses an end base at distal ends of the beam members. The end base can be advanced and retracted from the first position to the second position or from the second position to the first position. While advancing or retracting the end base, the length of the beam members can be controlled so that the end base can move in a relatively straight line.

Each beam member can be inflatable and is adapted to support a compression load upon being inflated to a predetermined pressure. The first embodiment of the delivery apparatus also includes a retractor, which is connected to a proximal end of the beam member for storing the beam member in a deflated state and for controlling the amount of the beam member extending from the retractor in an inflated state. The retractors of the second embodiments function in a similar fashion.

The delivery apparatus and methods can include an inflating system for inflating the beam member(s). The inflating system can be located at the distal end of the beam member(s) for inflating the same from the distal end of the beam member(s). The inflating system inflates the beam member(s) from the distal end of the beam member as the beam member(s) extends outwardly from the retractor(s). The inflating system can include a gas source and a compressor. The retractor(s) deflate the beam member(s) as the beam member(s) is stored in the retractor(s), and the compressor forces the gas expelled from the inflated beam member(s) into the gas source.

The end base can have a manipulator and a plurality of end thrusters.

### BRIEF DESCRIPTION OF THE DRAWINGS

These and other features, aspects, and advantages of the present invention will become more apparent from the following description, appended claims, and accompanying exemplary embodiments shown in the drawings, which are briefly described below.

FIG. 1 schematically illustrates a space shuttle with a delivery apparatus according to the present invention ready for delivering or retrieving objects to or from a space station positioned at a safe distance.

FIG. 2 schematically illustrates the manner in which a long elongated body can behave in space and the manner in which it can be controlled to form a straight line.

FIG. 3 schematically illustrates a retractor system incorporated in the delivery apparatus of FIG. 1.

FIG. 4 schematically illustrates an inflating system incorporated in the delivery apparatus of FIG. 1.

FIG. 5 schematically illustrates another embodiment of the delivery apparatus according to the present invention.

### DETAILED DESCRIPTION

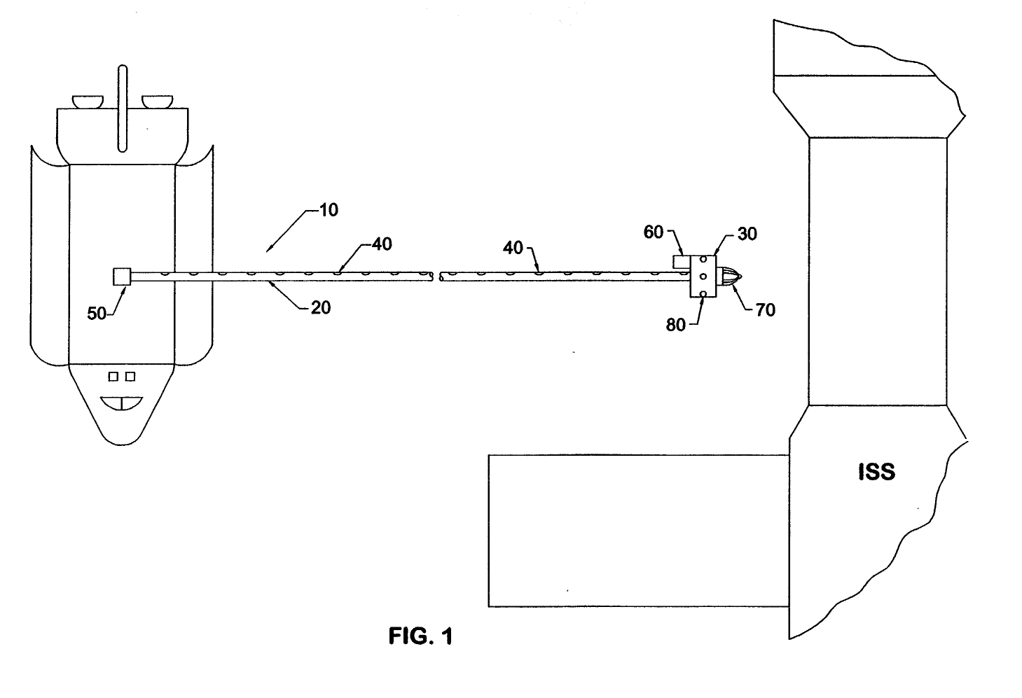

FIGS. 1-5 schematically depict first and second embodiments of a delivery apparatus 10 according to the present invention. The delivery apparatus 10 can manipulate objects such as cargo and astronauts, etc., between space vehicles or orbiting stations, such as the ISS, from a safe distance. The present invention allows transport of cargo without having to hard dock the space vehicles or maneuver within a potential collision zone of the vehicles. Moreover, the present delivery apparatus can vastly expand the operating envelope of present SSRMS, or can be used as an alternative to SSRMS mobile transport.

According to the first embodiment, as shown in FIG. 1, the delivery apparatus 10 includes a flexible beam member 20, an end base 30, a plurality of stabilizing thrusters 40, a retractor 50, and an inflating system 60. The flexible beam member 20 is inflatable to form a beam structure capable of withstanding compressive and bending forces, and has a predetermined length sufficient to reach the destination point. A manipulator 70 can be detachably mounted to the end base 30, which is connected to or formed at the distal end portion of the flexible beam member 20. The manipulator 70 can be any conventional type, such as the PDGF currently used in the Canadarm2, for holding cargo or latching onto the space vehicle. The stabilizing thrusters 40 are spaced along the length of the flexible beam member for stabilizing and guiding the flexible beam member in space, i.e., in a substantially gravity free or relatively low gravity environment, so that the end base 30 with the manipulator 70 can move in a relatively straight line. The stabilizing thrusters 40 can be positioned circumferentially around the beam member 20, spaced in a spiral configuration or along the same plane around the circumference thereof.

One way of keeping the inflated beam straight is by applying thrust at its distal end to maintain net tension in the inflated beam member 20. This approach, however, is believed to expend too much power, namely thrusting gas. The first embodiment instead uses the stabilizing thrusters 40 positioned at intervals along the length of the beam member 20. The stabilizing thrusters 40 can be placed at positions determined by Euler's formula. Specifically, the spacing between the thrusters is preferably less than the critical length according to Euler's formula, using the maximum compression (C) and the section bending stiffness (EI), on a slightly conservative formula for pin-ended beams since the bending moment between segments is merely to stabilize:

L_{crit}=(π²EI/C)^{1/2}

The stabilizing thrusters 40 can be remotely controlled to push the beam member 20 into alignment as necessary. Since the function of the thrusters 40 is to merely stabilize the beam member 20, only short bursts of low thrust are needed, consuming relatively a small amount of gas or propellant.

One convenient thrust source for the thrusters 40 is the gas or propellant inflating the beam member, i.e., the same gas used to pressurize the beam I used as the medium for the stabilizing thruster operation. In this respect, the stabilizing thrusters 40 can be a self contained valve that allows a small amount of gas from the inflated beam 20 to escape into space. As it is not desirable to run electrical conductors along the length of the inflated beam 20, as such conductors might generate unwanted charges while passing through the Earth's electromagnetic field, it is preferred that the valves can be remotely controlled from control signals generated by a CPU or microprocessor based controller (either a dedicated unit or part of the vehicles control system) and transmitted to the valves, either by wireless transmission or non-conductive optical fibers running through the inflated beam 20. In this respect, the valves are preferably operated with a self contained power source.

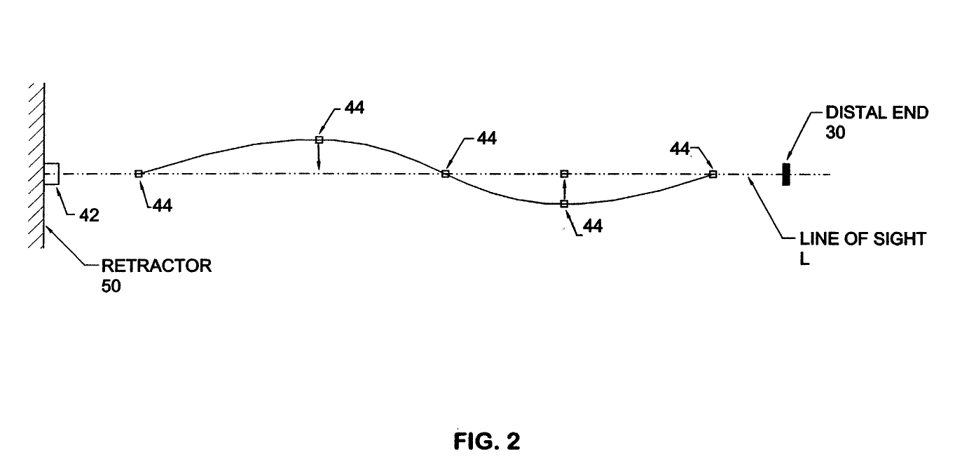

A laser guidance system can be employed to provide a reference straight line or a line of sight L. As shown in FIG. 2, at least one laser source 42 is provided at a location adjacent to the dispensing point of the inflated beam 20 from the retractor 50. Optical sensors 44 are placed at each thruster 40 to detect the amount of misalignment relative to the laser guide line L. Feedback signals from the optical sensors 44 are used by the controller to control the operation of the thrusters 40, in order to keep the beam member 20 aligned with the target. The stabilizing thrusters 40 can be viewed as “virtual guy wires.” Guy wires are the traditional way of stabilizing long columns on Earth. But there is no convenient way of attaching wires to stabilize the inflated beam 20 in space. The small thrusters presently contemplated can provide the same restoring forces that guy wires can provide.

The retractor 50 is connected to a proximal end of the beam member 20 for storing the same and for controlling the amount extending from the retractor 50. In other words, the retractor 50 controls the effective draw length of the beam member 20. The retractor 50 stores the beam member 20 in a deflated state. As the beam member 20 extends from the retractor 50, only the segment that extends outwardly from the retractor 50 becomes inflated.

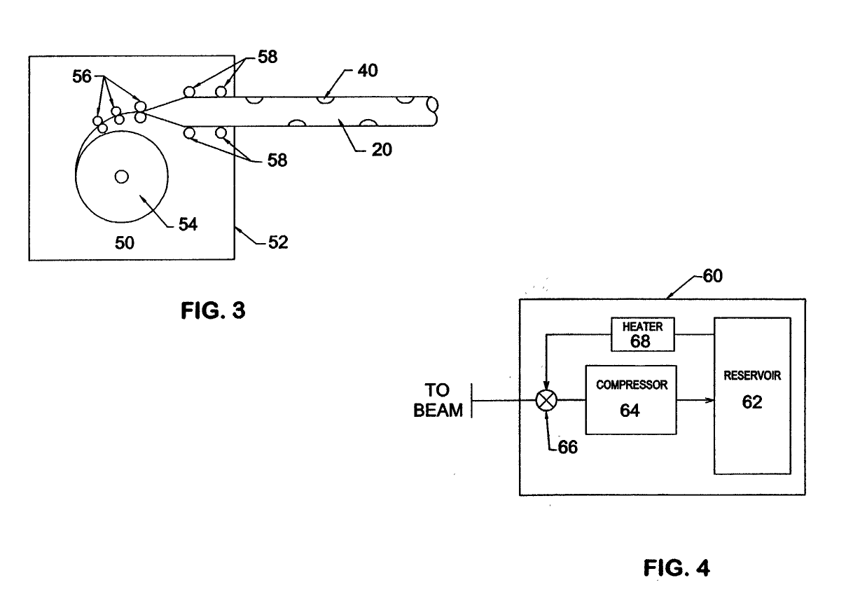

As shown in FIG. 3, the retractor 50 includes a housing 52, a powered or motorized reel 54, pinch rollers 56, and guide rollers 58. The powered reel 54, pinch rollers 56, and guide rollers 58 all can be journaled for rotation inside the housing. The proximal end of the beam member 20 is attached to the powered reel 54 so that the deflated beam member can be wrapped around or rolled up on the reel 54 (retracted) as it is rotated in one direction and unwrapped (extended) as it is rotated in the opposite direction. The guide rollers 58 can be circumferentially arranged in a cage structure for guiding the inflated portion of the beam member. In this respect, the guide rollers 58 can be positioned along a segment of the inflated beam member 20 sufficient to provide the end moment needed to support the inflated portion thereof. In other words, the guide rollers 58 are designed to support the inflated beam member 20 so that it does not fold or pinch at the point where the beam member 20 exits the retractor 50. The pinch rollers 56 separate the pressurized, inflated section of the beam member 20 from the deflated segment that is rolled up on the reel 54. The pinch rollers 56 also expel gas out of the beam member 20 as they squeeze and flatten the beam member just before it is rolled up on the reel. The pinch rollers 56 positioned along the length of the beam member 20 can frictionally drive the beam member 20 in both directions to extract or retract the same. The retractor 50 can be mounted to a space vehicle using a universal joint, so that the retractor 50 itself can freely pivot relative to the space vehicle. This allows the guide rollers 58 to be always in alignment with the direction in which the beam member 20 extends relative to the space vehicle.

In a preferred embodiment, the inflating system 60 is located at the distal end of the beam member 20, such as at the end base 30, so that the beam member 20′ can be inflated from the distal end side. The inflating system 60 is preferably controlled by the same controller used to control the thrusters 40 and the retractor 50 to inflate the beam member 20 as the beam member 20 extends outwardly from the retractor 50. As shown in FIG. 4, the inflating system 60 preferably includes a gas or propellant reservoir or source 62 and a compressor or pump 64. The retractor 50 deflates the beam member as the beam member 20 is retrieved into the retractor 50, and thus applies pressure. The compressor 64 can force the gas expelled from the inflated beam member 20 back into the gas source 62, thereby allowing the gas to be stored and reused. The inflating system 60 preferably further includes one or more discharge regulators/valves 66 for independently controlling the inflating pressure, and a heat source 68 for expanding the gas to be sent to the beam member 20 during inflation. The inflation gas also can be a room temperature cryogenic, such as ammonium, carbon dioxide, or a CFC, to minimize storage mass and volume.

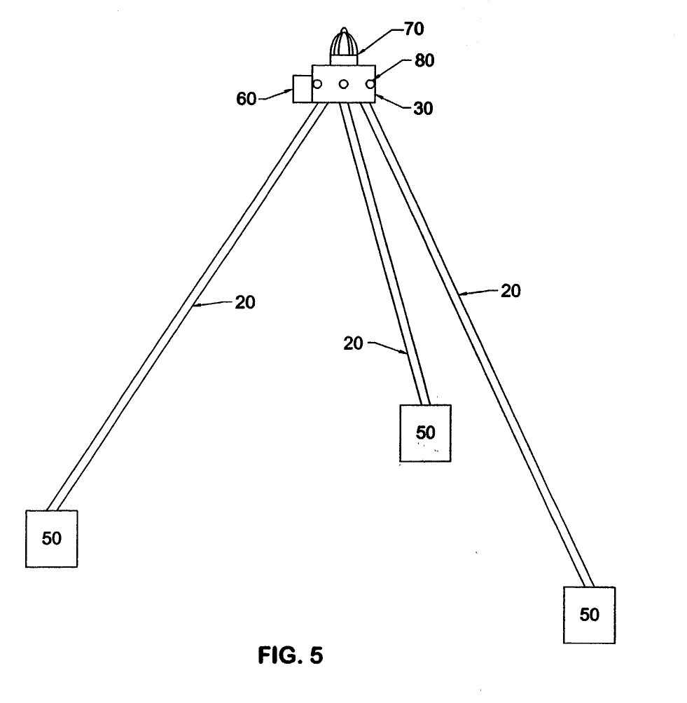

FIG. 5 schematically illustrates the second embodiment of the present delivery apparatus 10, which uses a plurality of flexible beam members 20. The use of multiple flexible beam members 20 enables the end base 30 to be positioned based on the various extension lengths of the beam members 20. Accordingly, the beam members 20 may not be required to include the thrusters 40 depending on the particular application, although the thrusters 40 may be desirable to provide additional stabilization. The same manipulator 70 can be attached to the end base 30, with a plurality of retractors 50 (corresponding in number with the beam members 20), and at least one inflating system 60 common to all beam members 20 (although multiple inflating systems maybe be employed). The illustrated embodiment has at least three inflatable beam members 20, but other configurations are possible including either additional beam members or fewer beam members.

The second embodiment can be used with a plurality of space vehicles, which can accommodate multiple, widely spaced anchor points. Such a delivery structure allows more precise manipulation within the volume defined by the anchor points and the inflated beam members 20. The multiple beam members 20 allow precise 3-D positioning of the manipulator 70 by controlling the length of each beam member.

In both embodiments, the end base 30 preferably has a plurality of thrusters, more preferably multi-axes thrusters 80, for precisely positioning the associated manipulator 70. When maneuvering the delivery apparatus 10, particularly to attach an object to the manipulator 70, it is not necessary to maintain the beam member 20 in a straight line. In the first embodiment, the manipulator 70 or end base 30 can be allowed to move faster than the stabilizing thrusters 40 can respond. When retracting the beam member 20 in the first embodiment, however, it is important to use the end thrusters 80 to keep the beam member 20 straight so that the beam member 20 can react to the compression to decelerate the cargo. As the cargo gets closer and the beam member 20 gets shorter, the ability of the beam member 20 to react to the compression greatly increases, and does not require active stabilization.

As described above, the beam member 20 is inflatable to form a beam or column upon inflation to a predetermined pressure for supporting compression and bending loads. The beam member 20 can be based on the inflatable structures manufactured by Vertigo, Inc. having high strength and stiffness. These structures are generally tubular when inflated, and can be used as beams, struts, or columns. Such structures are disclosed in U.S. Pat. Nos. 5,421,128; 5,677,023; and 5,735,083, the disclosures of which are incorporated herein by reference. These patents disclose the manufacturing technology involving braiding and reinforcing structures engineered to match particular requirement for strength or stiffness or both. Commercial structures utilizing this technology have a L/D (length/diameter) ratio of less than 50:1. Specifically, the tube length has a limit of 120 feet, with a diameter of 30 inches. At a working pressure of 85 psi, in an arch configuration, it can support a distributed load of 20,000 pounds while deflecting only inches.

Considering that the beam member 20 has to be stored in a flat (deflated) state, it is preferably that the beam member 20 be kept to a diameter of approximately 1 m. The length of the beam member 20 when fully deployed preferably exceeds 300 m (or around 1,000 ft). Accordingly, the beam member 20 contemplated for use in the present system with the same diameter of approximately 30 inches has a length than six-times longer than the conventional beam structures or an L/D ratio of about 300. Such ratios can be achieved using the thrusters 40 to actively stabilize the beam.

Other materials that can be used to construct a flexible beam member include recently developed structural fibers have outstanding characteristics in terms of dimensional stability, specific strength and specific modulus, and that can also be creased, folded and flexed without loosing properties. Examples are Vectran™ (outstanding for stability and flex fatigue) and Zylon® (outstanding for specific strength and specific modulus).

According to the present invention, objects can be transported across space between a first position and a second position with at least one flexible beam member having a length sufficient to span between the two points. A manipulator can be provided at the end base for holding cargo or latching to the space vehicle. The end base can be advanced or retracted from the first position to the second position or from the second position to the first position, while guiding and controlling the beam member to move in a relatively straight line during the advancing or retracting step. The beam member can be inflated as the beam member is advanced toward the second position. As the manipulator is retracted from the second position to the first position, the beam member can be deflated and stored. The beam member can be retracted and stored into a retractor in an inflated state and extended toward the second position in an inflated state. The beam member can be inflated from the distal end as the beam member extends from the retractor.

Another way of transporting cargo across space according to the present invention is by providing a plurality of flexible beam members having a length to span between the first and second positions, providing an end base at the distal end of the beam members, advancing or retracting the end base from the first position to the second position or from the second position to the first position, and controlling the length of the beam members so that the end base can move in a relatively straight line during the advancing or retracting step.

Given the disclosure of the present invention, one versed in the art would appreciate that there may be other embodiments and modifications within the scope and spirit of the present invention. As just one example, the reel 54 can be omitted, and instead, the beam member 20 can be stored in a folded fashion, such as in a serpentine configuration. Accordingly, all modifications attainable by one versed in the art from the present disclosure within the scope and spirit of the present invention are to be included as further embodiments of the present invention. The scope of the present invention accordingly is to be defined as set forth in the appended claims.

What is claimed is:

1. A delivery apparatus comprising:
at least one flexible beam member having a predetermined length;
an end base at a distal end of the beam member; and
a plurality of stabilizing thrusters spaced along the length of the beam member for stabilizing and guiding the beam member.

2. A delivery apparatus according to claim 1, wherein the beam member is inflatable.

3. A delivery apparatus according to claim 2, further including a retractor connected to a proximal end of the beam member for storing the beam member in a deflated state and for controlling the amount of the beam member extending from the retractor in an inflated state.

4. A delivery apparatus according to claim 2, further including an inflating system for inflating the beam member.

5. A delivery apparatus according to claim 4, wherein the inflating system is located at the distal end of the beam member for inflating the beam member from the distal end of the beam member.

6. A delivery apparatus according to claim 5, wherein the inflating system inflates the beam member from the distal end of the beam member as the beam member extends outwardly from the retractor.

7. A delivery apparatus according to claim 6, wherein the inflating system includes a gas source and a compressor, wherein the retractor deflates the beam member as the beam member is stored in the retractor, and the compressor forces the gas expelled from the inflated beam member into the gas source.

8. A delivery apparatus according to claim 1, further including a manipulator attached to the end base.

9. A delivery apparatus according to claim 8, wherein the end base has a plurality of thrusters.

10. A delivery apparatus comprising:
a plurality of flexible beam members each having a predetermined length;
an end base connected to a distal end of each of the beam members; and
a plurality of retractors corresponding in number with the beam members for storing the beam members and for controlling the length of the beam member extending from the retractor so that the end base moves in a relatively straight line.

11. A delivery apparatus according to claim 10, wherein each of the beam members is inflatable.

12. A delivery apparatus according to claim 11, wherein each of the retractors stores the respective beam member in a deflated state, and the beam member extends from the retractor in an inflated state.

13. A delivery apparatus according to claim 12, further including an inflating system for inflating the beam member.

14. A delivery apparatus according to claim 12, wherein the inflating system is located at the end base for inflating the beam members from distal ends thereof, wherein the inflating system inflates the beam members as the beam members extend from retractor.

15. A delivery apparatus according to claim 14, wherein the inflating system includes a gas source and a compressor, wherein the retractors deflate the beam members as the beam members are retrieved into the retractor, and the compressor forces the gas expelled from the inflated beam members into the gas source.

16. A delivery apparatus according to claim 10, wherein the end base has a plurality of thrusters.

17. A delivery apparatus according to claim 10, further comprising a plurality of stabilizing thrusters spaced along the length of at least one of the beam members.
